(19) United States
(12) Patent Application Publication
(10) Pub. No.: US 2026/0202672 A1
(43) Pub. Date: Jul. 16, 2026

(54) NEAR-EYE LIGHT-FIELD PROJECTION SYSTEM HAVING ACTIVE FOVEATION

(71) Applicant: Creal SA, Ecublens VD (CH)

(72) Inventors: Jonathan Masson, Puidoux (CH); Grégoire Smolik, Chavannes-près-Renens (CH); Tomas Sluka, Lausanne (CH)

(73) Assignee: Creal SA, Ecublens VD (CH)

(21) Appl. No.: 19/132,106

(22) PCT Filed: Dec. 9, 2022
(86) PCT No.: PCT/IB2022/061989

§ 371 Date: May 22, 2025

(51) Int. Cl. G02B 27/01; G02B 27/00; H04N 13/344; H04N 13/363; H04N 13/383

(52) U.S. Cl. CPC G02B 27/0172; G02B 27/0025; G02B 27/0081; G02B 27/0093; H04N 13/344; H04N 13/363; H04N 13/383; G02B 2027/0123

(57) ABSTRACT

A near-eye light-field projection system has a light source generating incident light beams and a spatial light modulator projecting a plurality of modulated light-beams. A first optical element forms a plurality of light source images in a light source image plane. A second optical element forms modulator images in a modulator image plane. A third optical element provides a first field of view (FOV) and projects a plurality of projected viewpoints in an exit plane. An active deflecting element deflects the modulated light beams, based on an orientation of a pupil of a user's eye, to provide a plurality of deflected modulated light beams spatially shifting the modulator images in the modulator image plane, forming a second FOV larger than the first FOV in the direction of the pupil orientation, and the projected viewpoints forming a second exit pupil in the exit plane.

### TECHNICAL DOMAIN

The present disclosure relates to a near-eye light-field projection system that sequentially projects a near-eye projected image to the eyes of a user. More particularly, the present disclosure concerns a near-eye light field projection system that is adapted for virtual, augmented, mixed reality glasses applications. The present disclosure further concerns a wearable device comprising the near-eye light field projection system, such as augmented/mixed reality or smart glasses.

### RELATED ART

The human eye has a very wide field of view (FOV). Individually, the human eye has a horizontal FOV of about 135° and a vertical FOV of just over 180°. The FOV allows for coverage of an area rather than a single focused point. In virtual reality (VR) and/or mixed reality devices, a large FOV is essential to getting an immersive, life-like experience. A wider FOV also provides better sensor coverage or accessibility for many other optical devices.

In practice, a virtual or mixed reality device should be able to provide about 400 000 000 pixels to cover the human eye FOV with regularly distributed pixels to satisfy the highest resolution of the eye.

However, the resolution of an eye is not evenly distributed. It has high resolution only in about 20° FOV around its fovea. A full HD display (1920×1080) covering 20° FOV already reaches retinal resolution at fovea. The eye resolution gradually drops farther from fovea. The whole FOV (outside fovea) can be covered with about the same amount of information as inside the fovea, putting the total number of pixels needed to about 4 000 000.

So-called foveated rendering and projection is being introduced to virtual, mixed and augmented reality headsets to exploit exactly this feature of human vision. But this is still performed with flat images. Light-field devices do not have any solution yet for foveated projection nor active foveated projection.

European patent EP3542206B1 by the present applicant discloses a light-field projector for projecting a virtual image to the eyes of a user having optimized monocular depth cues, and an augmented reality device comprising the light-field projector. The near-eye light-field projector disclosed in this document produces a light-field with realistic monocular depth cues which creates viewer's perception of the realistic finite depth of field and correct accommodation in an artificially generated 3D scene.

International patent application WO2021090107 by the present applicant discloses a near-eye light-field virtual and mixed reality system having foveated projection. The system provides virtual and mixed reality experience to the eyes of any human, animal or a camera, such that a user can experience realistic mixing of real and virtual 3D scenes. The system can deliver 3D virtual and augmented reality information with the comfort of the correct eye accommodation.

FIG. 1a illustrates a light-field projection system as described in WO2021090107. The light-field projection system comprises a light source array 10 generating a plurality of incident light beams 100 illuminating a spatial light modulator (SLM) 20. The SLM 20 is configured for modulating the incident light-field 100 and projecting a plurality of modulated light-field components 110 along a projection axis 170. The light-field projection system further comprises a first optical element 70 configured to interact with the modulated light beams 110 and form a plurality of light source images 28 in a light source image plane 30. A second optical element 32 is configured to interact with the modulated light beams 110 and form modulator images 114 in a modulator image plane 115. A third optical element 40 is configured to interact with the modulated light beams 110 to project a plurality of projected viewpoints 112 forming an exit pupil 120 in an exit plane 125. An optical device 60 arranged at the light source image plane 30 is configured to deflect one or a portion of the modulated light-field components 110, such that the modulator image 114 formed by the deflected one or portion of the modulated light-field components 110 is spatially shifted in the modulator image plane 115. The deflected one or a portion of the modulated light-field components 110 can increase the FOV of at the exit pupil 120. FIGS. 1b and 1c shows an example of image tiling resulting from the expansion of the FOV using the light-field projection system as disclosed in WO2021090107, as seen by a viewer when a viewer's eye focuses at infinity (FIG. 1b) and closer than at infinity (FIG. 1c).

There are several disadvantages to deflecting only one or a portion of the modulated light-field components 110. For instance, the light field effect is reduced or cancelled if only one or a portion of the modulated light-field components 110 are deflected. The apparent brightness of the expanded FOV is reduced compared to the rest of the original FOV (corresponding to the non-deflected modulated light-field components 110) because a smaller number of viewpoints contribute to the total brightness. For a large expanded FOV, the exit pupil 120 may be too small so that the user's eye will be outside of the exit pupil 120 as it rotates to look at the expanded FOV.

### SUMMARY

The present disclosure concerns a near-eye light-field projection system, comprising a light source array generating a plurality of incident light beams illuminating a SLM configured to modulate the incident light beams and project a plurality of modulated light-beams. A first optical element is configured to interact with the modulated light beams and form a plurality of light source images in a light source image plane. A second optical element is configured to interact with the modulated light beams and form modulator images in a modulator image plane. A third optical element is configured to interact with the modulated light beams such as to provide a first FOV and project a plurality of projected image components forming a first exit pupil in an exit plane. The projection system further comprises at least one active deflecting element between the first and third optical elements. The active deflecting element is configured to, based on an orientation of a pupil of a user's eye, deflect the modulated light beams to provide a plurality of deflected modulated light beams spatially shifting the modulator images in the modulator image plane. The deflected modulated light beams form a second FOV, larger than the first FOV in the direction of the pupil orientation, and the projected image components form a second exit pupil in the exit plane.

With respect to what is known in the art, the near-eye light-field projection system disclosed herein allows for deflecting all modulated light beams projected by the SLM, such that the apparent brightness of the expanded second FOV is not reduced compared to the brightness of the first FOV.

The orientable high resolution FOV allows for a seamless experience for the user that only perceives a high-resolution light field image, while reducing the computing power and size of the projection system.

### SHORT DESCRIPTION OF THE DRAWINGS

Exemplar embodiments of the invention are disclosed in the description and illustrated by the drawings in which:

FIG. 1a illustrates a light-field projection system comprising an optical light modulator projecting modulated light-field components and an optical device configured to deflect one or a portion of the modulated light-field components;

FIGS. 1b and 1c show projected images of the optical light modulator as seen by a viewer when a viewer's eye focuses at infinity (FIG. 1b) and closer than at infinity (FIG. 1c);

FIG. 2 illustrates a near-eye light-field projection system, according to an embodiment;

FIG. 3 illustrates an eye-tracking device of the projection system, according to an embodiment;

FIG. 4 illustrates the projection system, according to another embodiment;

FIG. 5 shows the projection system, according to yet another embodiment; and FIG. 6 shows an alternative configuration of the projection system of FIG. 5.

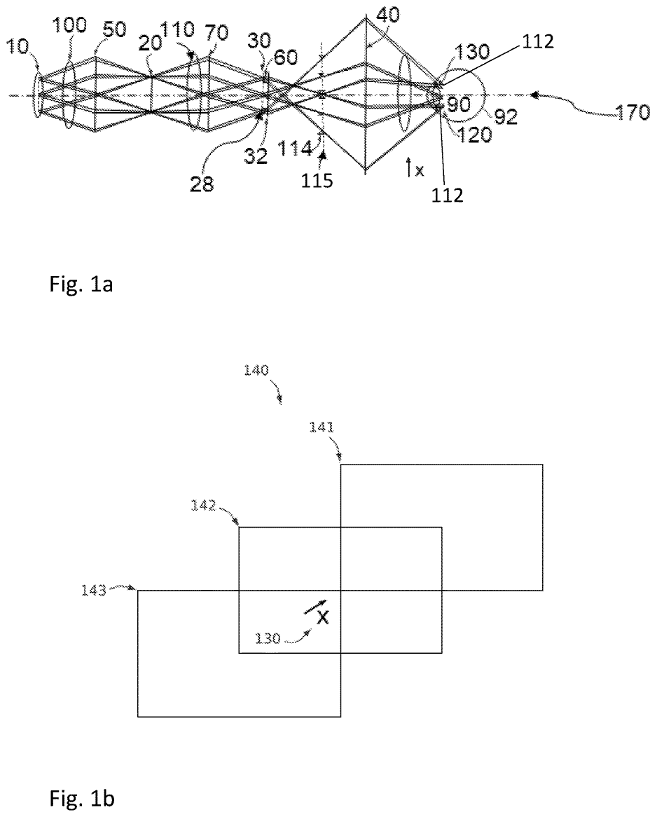

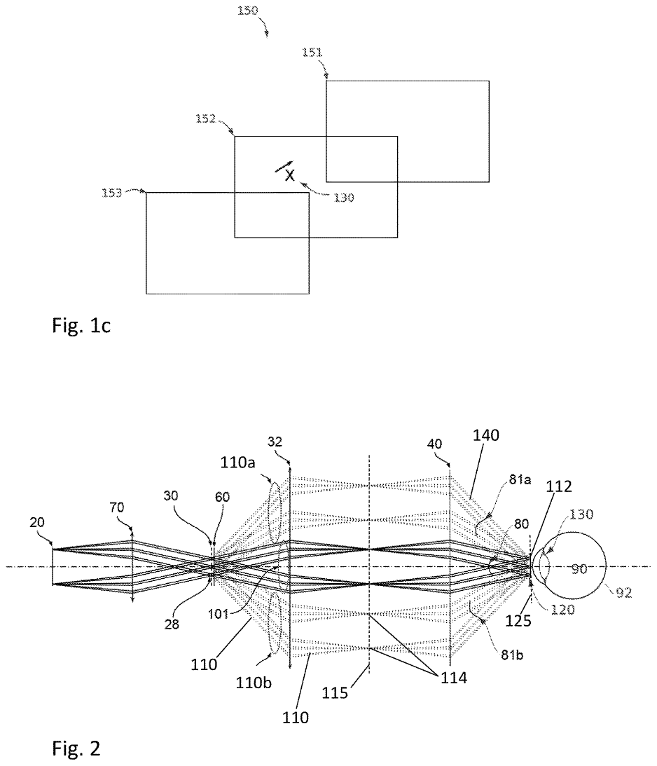

### EXAMPLES OF EMBODIMENTS

FIG. 2 illustrates a near-eye light-field projection system according to an embodiment. The projection system comprises a light source array (not represented) generating a plurality of incident light beams 100 sequentially illuminating a SLM 20 from different angles. The SLM 20 is configured to modulate the incident light beams 100 and project a plurality of modulated light-beams 110. The projection system further comprises a first optical element 70 configured to interact with the modulated light beams 110 and form a plurality of light source images 28 in a light source image plane 30.

The projection system further comprises a second optical element 32 configured to interact with the modulated light beams 110 and form modulator images 114 in a modulator image plane 115.

The projection system further comprises a third optical element 40 configured to interact with the modulated light beams 110 such as to provide a first FOV 80, and project a plurality of projected viewpoints 112 forming a first exit pupil 120 in an exit plane 125.

The projection system further comprises a deflecting element 60 configured to deflect the modulated light beams 110 such as to provide deflected modulated light beams 110a, 110b spatially shifting the modulator images 114 in the modulator image plane 115. The deflected modulated light beams 110a, 110b form a second FOV 81a, 81b, and the projected viewpoints 112 form a second exit pupil 121a, 121b in the exit plane 125. The second FOV 81a, 81b is formed in accordance with the direction of the user's pupil 130 orientation. For example, when the user is looking in a first direction (up in the example of FIG. 2), he will see the deflected modulated light beams 110 deflected by the deflecting element 60 and the expanded second FOV 81a in this first direction. When the user is looking in a second direction (down in the example of FIG. 2), he will see the deflected modulated light beams 110 deflected by the deflecting element 60 and the expanded second FOV 81b in this second direction. The second FOV 81a, 81b is thus larger than the first FOV 80 in the direction of the user's pupil 130 orientation. The content of the modulator images 114 in the expanded second FOV 81a, 81b is adapted accordingly to the user's pupil 130 orientation and the expanded second FOV 81a, 81b. This is achieved by controlling the SLM 20 based on the orientation of the user's pupil 130.

In one aspect, the deflecting element 60 is “passive” and is arranged to deflect all the modulated light beams 110 projected by the SLM. In that case, the apparent brightness of the expanded second FOV 81a, 81b is not reduced compared to the brightness of the first FOV 80.

In another aspect, the deflecting element 60 is “active” and configured to deflect the modulated light beams 110 based on an orientation of the user's pupil 130. In this configuration, the first and second exit pupils 120, 121a, 121b are formed sequentially. In other words, when the user is looking in the first direction, the deflecting element 60 deflects the modulated light beams 110 and forms the first FOV 81a, expanding the FOV in the first direction. When the user is looking in the second direction, the deflecting element 60 deflects the modulated light beams 110 and forms the second FOV 81b, expanding the FOV in the second direction.

The active deflecting element 60 can be configured to form and tile any type of pattern of the second FOV 81a, 81b. For example, the active deflecting element 60 can be configured to form the second FOV 81a, 81b having a square pattern, rectangular pattern, hexagonal pattern. The second FOV 81a, 81b can overlap or not to the first FOV 80.

The first optical element 70 and the second optical element 32 can comprise an imaging lens.

The third optical element 40 can comprise an eyepiece or a combiner. The combiner 40 can be configured for transmitting natural light from the real world towards the first and second exit pupil 120, 121a, 121b, such that the modulated light beams 110 and the deflected modulated light beams 110a, 110b and natural light are projected, via the combiner, within the first and second exit pupil 120, 121a, 121b.

In some embodiments, the deflecting element 60 is between the first optical element 70 and the second optical element 32. More particularly, the deflecting element 60 can be at a distance less than 20 mm from the light source image plane 30. For example, the deflecting element 60 can be arranged at the light source image plane 30. In the configuration where the deflecting element 60 is positioned at a distance less than 20 mm from the light source image plane 30, the second exit pupil 121a, 121b is not significantly spatially shifted in the exit plane 125 relative to the first exit pupil 120. In the case the deflecting element 60 is at the light source image plane 30, the second exit pupil 121a, 121b is spatially coincident with the exit pupil 120 in the exit plane 125.

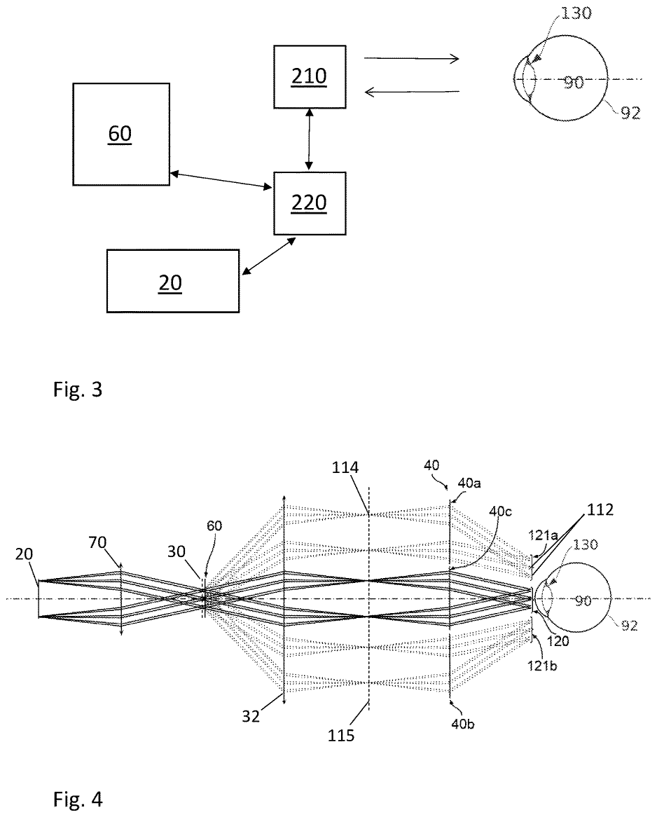

As illustrated in FIG. 3, the projection system can comprise an eye-tracking device 210 configured to measure the orientation of the user's pupil 130. The eye-tracking device 210 can be configured to control the SLM 20 such as to adapt the content of the modulator images 114 in the expanded second FOV 81a, 81b in accordance to the user's pupil 130 orientation. In other words, the eye-tracking device 210 can be configured to control the SLM 20 such that the content of the modulator images 114 comprises the image information (generated by the SLM) that the user would see when looking in the direction of the pupil 130 orientation. The eye-tracking device 210 can control the SLM 20 directly or via a controller or actuator 220, as shown in FIG. 3.

In the case where the deflecting element 60 is configured to deflect the modulated light beams 110 based on an orientation of the user's pupil 130, the deflecting element 60 can be controlled by the eye-tracking device 210 directly or via a controller or actuator 220, as shown in FIG. 3.

In an embodiment, the third optical element 40 can be configured such that the second exit pupil 121a, 121b is spatially shifted in the exit plane 125 relative to the first exit pupil 120.

FIG. 4 illustrates the projection system wherein the third optical element 40 comprises a plurality of sub-elements 40a, 40b, 40c. Each sub-element 40a, 40b, 40c is configured to interact with the deflected modulated light beams 110a, 110b and shift the second exit pupil 121a, 121b in the exit plane 125 relative to the first exit pupil 120. More particularly, each sub-element 40a, 40b, 40c can be configured to interact with the deflected modulated light beams 110 deflected by the active deflecting element 60 in a given direction and shifts the second exit pupil 121a, 121b, where shifting the second exit pupil 121a, 121b depends on the configuration of the sub-elements 40a, 40b, 40c. In this configuration, the position of the second exit pupil 121a, 121b and of the second FOV 81a, 81b in the exit plane 125 can be performed simultaneously. In one aspect, each sub-element 40a, 40b, 40c can comprise an additional optical function such as to obtain better optical quality at the viewpoints 112 in the image second exit pupil 121a, 121b. For example, each sub-element 40a, 40b, 40c can be configured to adapt the optical power or to correct optical aberrations.

The virtual content at the first exit pupil 120 and the second exit pupil 121a, 121b incoming respectively from the first FOV 80 and the second FOV 81a, 81b can be identical.

In the case the deflecting element 60 is “passive”, the size of the first and second exit pupils 120, 121a, 121b should not be smaller than the size of the user's pupil. Preferably, the size of the first and second exit pupils 120, 121a, 121b should be at least as large as the size of the user's pupil to avoid replication of the content in the wrong FOV. Typically, the pupil of the human eye has an average size of 4 mm. In the case the deflecting element 60 is “active”, the deflecting element 60 can be smaller than the user's pupil 130.

Two second exit pupils 121a, 121b are represented in FIG. 4, in addition to the first exit pupil 120. However, the projection system can be configured to form any number of second exit pupils 121a, 121b. Moreover, the second exit pupils 121a, 121b can be formed in one-dimensional or two-dimensional fashion.

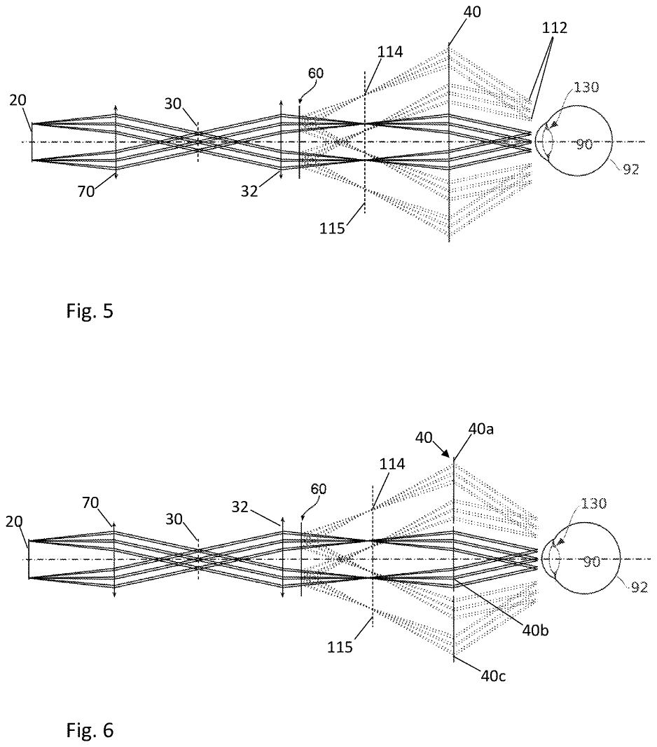

FIG. 5 illustrates the projection system according to another configuration, where the active deflecting element 60 is between the second optical element 32 and the modulator image plane 115. More generally, the active deflecting element 60 can be distant from the light source image plane 30 by a distance that is at least greater than 20 mm, towards the modulator image plane 115. In this configuration, the deflected modulated light beams 110a, 110b forms the second FOV 81a, 81b larger than the first FOV 80 and forms the second exit pupil 121a, 121b having a greater size than the first exit pupil 120. In this configuration, the active deflecting element 60 is configured to, based on the orientation of the pupil, simultaneously shift the second exit pupil 121a, 121b and the second FOV 81a, 81b in the exit plane 125, relative to the first exit pupil 120 and the first FOV 80 respectively. Here, the projection system allows for simultaneously shifting the second exit pupil 121a, 121b and the second FOV 81a, 81b without the use of the third optical element 40 comprising the sub-elements 40a, 40b, 40c.

FIG. 6 illustrates an alternative configuration of the projection system of FIG. 5. Here, wherein the third optical element 40 comprises a plurality of sub-elements 40a, 40b, 40c, each sub-element 40a, 40b, 40c being configured to interact with the deflected modulated light beams 110, 110b. The sub-elements 40a, 40b, 40c allow for controlling the position of the second exit pupil 121a, 121b more precisely than when using the third optical element 40 comprising a single part.

In one aspect, the sub-element 40a, 40b, 40c can be further configured to adapt the optical power and/or correct optical aberrations.

In the configurations of FIGS. 4 and 6, the third optical element 40 is shown comprising three sub-elements 40a, 40b, 40c. However, the third optical element 40 can comprise more than three sub-element 40a, 40b, 40c.

The third optical element 40 and sub-element 40a, 40b, 40c can comprise any one of: a holographic optical element (HOE), an active liquid crystal polarization grating (LCPG), an active metasurface, a diffractive optical element (DOE), a flat or curved mirror (spherical, parabolic, aspherical, freeform, ellipsoidal), or any combination thereof. The shifting of the second exit pupil 121a, 121b depends on the properties of the sub-element 40a, 40b, 40c. The sub-elements 40a, 40b, 40c allow for the spatial position of the second exit pupil 121a, 121b to be spatially shifted with increased accuracy The active deflecting element 60 can comprise any one of: an active liquid crystal polarization grating (LCPG), a Pancharatnam-Berry grating (PG), a micro-electro-mechanical system (MEMS) mirror, an active phase modulator, a liquid crystal on silicon (LCOS, FLCOS), an active metasurface, an active refractive optical element such as a rotating, sliding or tilting wedge, or any combination thereof.

In the projection system disclosed herein, the second FOV 81a, 81b is orientable in the direction of the user's pupil, such that the first and second FOV 80, 81a, 81b can be smaller (for example 30°) and with a higher resolution than the FOV usually used in known near-eye light-field projection systems (for example 60°). The projection system can thus be smaller than the known projection systems.

The projection system can be advantageously used in near-eye light-field virtual and mixed reality systems, and in particular in near-eye light-field virtual and mixed reality systems having foveated projection.

The present disclosure further concerns a wearable device comprising the near-eye light field projection system. The wearable device can comprise an augmented reality device, a wearable mixed reality device, or smart glasses.

### REFERENCE NUMBERS AND SYMBOLS

10 light source array
20 spatial light modulator (SLM)
28 light source image
30 light source image plane
32 second optical element
40 third optical element
40a, b, c combiner sub-elements
60 active deflecting element
70 first optical element
80 first field of view (FOV)
81a, 81b second FOV
90 eye
100 incident light-beam
110 modulated light-beam
110a, 110b deflected modulated light beam
112 projected viewpoint
114 modulator image
115 modulator image plane
120 first exit pupil
121a, b second exit pupil
125 exit plane
130 pupil
140 image light-beam
170 projection axis
210 eye-tracking device
220 actuator

1. A near-eye light-field projection system for projecting images to a user's eye, comprising:
a light source array generating a plurality of incident light beams illuminating a spatial light modulator configured to modulate the incident light beams and project a plurality of modulated light-beams;
a first optical element configured to interact with the plurality of modulated light beams and form a plurality of light source images in a light source image plane;
a second optical element configured to interact with the plurality of modulated light beams and form modulator images in a modulator image plane; and
a third optical element, configured to interact with the plurality of modulated light beams such as to provide a first field of view (FOV) and project a plurality of projected viewpoints forming a first exit pupil in an exit plane;
wherein the system further comprises an eye-tracking device configured to determine the orientation of the pupil of the user's eye and to adapt the content of the modulator images in an expanded second FOV in accordance to the user's pupil orientation; and
at least a deflecting element between the first and third optical elements, the deflecting element being configured to, based on an orientation of a pupil of a user's eye, deflect the plurality of modulated light beams to provide a plurality of deflected plurality of modulated light beams spatially shifting the modulator images in the modulator image plane the deflected plurality of modulated light beams forming a second FOV larger than the first FOV in the direction of the pupil orientation, and the projected viewpoints forming a second exit pupil in the exit plane.

2. The projection system according to claim 1, wherein the deflecting element is between the first and second optical elements.

3. The projection system according to claim 2, wherein the deflecting element is at a distance less than 20 mm from the light source image plane.

4. The projection system according to claim 3, wherein the deflecting element is at the light source image plane and the second exit pupil is spatially coincident with the first exit pupil in the exit plane.

5. The projection system according to claim 2, wherein the third optical element is configured such that the second exit pupil is spatially shifted in the exit plane relative to the first exit pupil.

6. The projection system according to claim 5, wherein the deflecting element is configured to sequentially shift the second exit pupil.

7. The projection system according to claim 1, wherein the third optical element comprises a plurality of sub-elements, each sub-element being configured to interact with the deflected plurality of modulated light beams and based on the orientation of the pupil, shift the second exit pupil in the exit plane relative to the first exit pupil.

8. The projection system according to claim 1, wherein the deflecting element is active and distant from the light source image plane by a distance that is at least greater than 20 mm, towards the modulator image plane; and wherein the second exit pupil has a greater size than the first exit pupil.

9. The projection system according to claim 8, wherein the active deflecting element is configured to, based on the orientation of the pupil, simultaneously shift the second exit pupil and the second FOV in the exit plane, relative to the first exit pupil and the first FOV respectively.

10. The projection system according to claim 8, wherein the third optical element comprises a plurality of sub-elements each sub-element being configured to interact with the deflected plurality of modulated light beams.

11. The projection system according to claim 7, wherein the third optical element and/or the sub-element comprises any one of: a holographic optical element (HOE), an active or passive liquid crystal polarization grating (LCPG), an active or passive metasurface, a diffractive optical element (DOE), a flat or curved mirror, or any combination thereof.

12. The projection system according to claim 7, wherein the sub-element is configured to adapt the optical power and/or correct optical aberrations of the third optical element.

13. The projection system according to claim 8, wherein the active deflecting element comprises any one of: an active liquid crystal polarization grating (LCPG), a Pancharatnam-Berry grating (PG), a micro-electro-mechanical system (MEMS) mirror, an active phase modulator, a liquid crystal on silicon (LCOS, FLCOS), an active metasurface, an active refractive optical element such as a rotating, sliding or tilting wedge, or any combination thereof.

14. The projection system according to claim 8, wherein the eye-tracking device is configured to control the active deflecting element to deflect the plurality of modulated light beams.

15. A wearable device comprising a near-eye light field projection system comprising:
a light source array generating a plurality of incident light beams illuminating a spatial light modulator configured to modulate the incident light beams and project a plurality of modulated light-beams;
a first optical element configured to interact with the plurality of modulated light beams and form a plurality of light source images in a light source image plane;
a second optical element configured to interact with the plurality of modulated light beams and form modulator images in a modulator image plane; and
a third optical element, configured to interact with the plurality of modulated light beams such as to provide a first field of view (FOV) and projected a plurality of projected viewpoints forming a first exit pupil in an exit plane:
wherein the system further comprises an eye-tracking device configured to determine the orientation of the pupil of the user's eye and to adapt the content of the modulator images in an expanded second FOV in accordance to the user's pupil orientation; and
at least a deflecting element between the first and third optical elements, the deflecting element being configured to, based on an orientation of a pupil of a user's eye, deflect the plurality of modulated light beams to provide a plurality of deflected plurality of modulated light beams spatially shifting the modulator images in the modulator image plane, the deflected plurality of modulated light beams forming a second FOV, larger than the first FOV in the direction of the pupil orientation, and the projected viewpoints forming a second exit pupil in the exit plane.

16. The wearable device according to claim 15, comprising an augmented reality device, a wearable mixed reality device, or smart glasses.
